(19) United States
(12) Patent Application Publication
(10) Pub. No.: US 2024/0403756 A1
(43) Pub. Date: Dec. 5, 2024

(54) PROTOCOL EVALUATION SUPPORT APPARATUS AND PROTOCOL EVALUATION SUPPORT METHOD

(71) Applicant: Hitachi, Ltd., Tokyo (JP)

(72) Inventors: Takayuki Kanda, Tokyo (JP); Hiroyuki Suzuki, Tokyo (JP); Hiroyuki Yamamoto, Tokyo (JP); Sayaka Kurata, Tokyo (JP)

(21) Appl. No.: 18/591,334

(22) Filed: Feb. 29, 2024

(30) Foreign Application Priority Data
Jun. 2, 2023 (JP) 2023-091481

(51) Int. Cl. G06Q 10/0631

(52) U.S. Cl. CPC G06Q 10/06313

(57) ABSTRACT

A processing device included in a protocol evaluation support apparatus executes creation processing (S302 and S303) for creating a simultaneous merging symbol at a portion in a protocol where a plurality of elements simultaneously merge into one element, and creating a simultaneous branching symbol at a portion in a protocol where one element simultaneously branches to a plurality of elements, development processing (S304) for developing the protocol for each of paths included in the process procedure, removal processing (S305 and S306) for removing all of the elements that are duplicated in a process after the simultaneous merging symbol and removing all of the elements that are duplicated in a process before the simultaneous branching symbol for the protocol, and calculation processing for making each of individual evaluation values correspond to each of the remaining elements and calculating an overall evaluation value of the protocol based on the individual evaluation values made to correspond to the remaining elements for the protocol.

### BACKGROUND OF THE INVENTION

### 1. Field of the Invention

The present disclosure relates to a protocol evaluation support apparatus and a protocol evaluation support method.

### 2. Description of Related Art

In setting a process procedure (also called a work procedure), it is necessary to consider evaluation items such as cost and time for a combination of various elements that configure the procedure, and the setting work thereof requires a lot of effort. As a technology related to support for such setting work, for example, there is a support technology that supports data analysis work (see WO2015/186249).

WO2015/186249 describes a data analysis work support device that supports data analysis work that flexibly copes with changes in conditions while taking into account the efficiency and diversity of analysis work.

By the way, examples of the setting work accompanied by difficulties as described above include the setting work of an experimental procedure in materials research. In research and development on materials, there exist various elements (processes) such as raw materials and their processing, measurement, and analysis, and there are many types of elements, and thus, various combinations may exist. In many cases, the process procedure includes a plurality of paths, and the merging or the branching of the paths, and thus contents of the process procedure are often complicated, and their settings require detailed examination by an expert.

Therefore, it is possible to support the setting of the process procedure by storing data of a protocol in which the process procedure (for example, experimental procedure) in materials research and the like is expressed, and calculating an evaluation value such as the cost of executing the process procedure as necessary based on this protocol.

In the related art, a protocol in which the process procedure is expressed in the form of a directed graph is evaluated based on the importance of the branching included in the protocol. For example, in the field of materials research as well, it is expected that the protocol in which the process procedure is expressed in the form of the directed graph will be appropriately evaluated.

However, for example, in the field of materials research, it is difficult to appropriately evaluate the protocol in which the process procedure is expressed. In materials research, when using a plurality of types of raw materials, in addition to a case where the plurality of types of raw materials are used individually, there may also be a case where the plurality of types of raw materials are used simultaneously. In other words, in a protocol in which the process procedure in materials research is concisely expressed, when there are paths in which the plurality of elements (for example, raw materials) merge into one element, there may be a case where the plurality of elements proceed to the next element individually, and a case where the plurality of elements proceed to the next element simultaneously (also called “all at once”). In other words, the “merging” described above may include the meanings of “merging individually” and “merging simultaneously”.

Similarly, in the protocol in which the process procedure in materials research is expressed, there may be a case where one element branches into the plurality of elements, and this “branching” may include the meanings of “branching individually” and “branching simultaneously”.

In order to properly evaluate the protocol, it is necessary to correctly express how many times which element appears. In order to do so, it is necessary to be able to handle both the two types of meanings of “individual” and “simultaneous” in relation to the meanings of “merging” and “branching” described above.

However, the related art cannot deal with this point. In the protocol expressed by the directed graph in the related art, the “merging” and “branching” described above are handled on the assumption that the “merging” and “branching” have the meaning of “individual”, and it is difficult to express the meaning of “simultaneous”. When the meaning of “simultaneous” cannot be handled, there is a risk that the number of times the element appears may be excessive compared to the original protocol contents. Accordingly, there is a risk that an evaluation value such as the cost based on the number of times the element appears cannot be correctly calculated.

### SUMMARY OF THE INVENTION

Therefore, an object of the present disclosure is to provide a technology that enables support for appropriately evaluating a protocol in which a process procedure including a plurality of paths is expressed.

A protocol evaluation support apparatus according to an embodiment supports an evaluation of a protocol in which a process procedure including a plurality of paths that connect a plurality of elements is expressed, and includes a processing device. The processing device executes creation processing for creating a simultaneous merging symbol that specifies simultaneous merging at a portion in the protocol where a plurality of the elements simultaneously merge into one element, and creating a simultaneous branching symbol that specifies simultaneous branching at a portion in the protocol where one element simultaneously branches to a plurality of the elements, and development processing for developing the protocol after being subjected to the creation processing for each of the paths included in the process procedure. Furthermore, the processing device executes removal processing for removing all of the elements that are duplicated in a process after the simultaneous merging symbol and removing all of the elements that are duplicated in a process before the simultaneous branching symbol for the protocol after being subjected to the development processing, and calculation processing for making each of individual evaluation values correspond to each of the remaining elements and calculating an overall evaluation value of the protocol based on the individual evaluation values made to correspond to the remaining elements for the protocol after being subjected to the removal processing.

According to the protocol evaluation support apparatus according to the embodiment, it is possible to provide support for appropriately evaluating the protocol in which the process procedure is concisely expressed.

### BRIEF DESCRIPTION OF THE DRAWINGS

FIG. 1 is an overall configuration diagram of a protocol evaluation support apparatus according to Embodiment 1;

FIG. 2 is a functional block diagram of the protocol evaluation support apparatus according to Embodiment 1;

FIG. 3 is a diagram illustrating an example of a flow of a protocol evaluation support process according to Embodiment 1;

FIG. 4A is a diagram illustrating an example of protocol data according to Embodiment 1;

FIG. 4B is a diagram illustrating an example of the protocol data according to Embodiment 1;

FIG. 5A is a diagram illustrating an example of creation processing according to Embodiment 1;

FIG. 5B is a diagram illustrating an example of the creation processing according to Embodiment 1;

FIG. 6 is a diagram illustrating an example of development processing according to Embodiment 1;

FIG. 7A is a diagram illustrating an example of removal processing according to Embodiment 1;

FIG. 7B is a diagram illustrating an example of the removal processing according to Embodiment 1;

FIG. 8A is a diagram illustrating an example of the removal processing according to Embodiment 1;

FIG. 8B is a diagram illustrating an example of the removal processing according to Embodiment 1;

FIG. 9 is a diagram illustrating an example of calculation processing according to Embodiment 1;

FIG. 10 is a diagram illustrating an example of a display screen of the protocol evaluation support apparatus according to Embodiment 1;

FIG. 11 is a diagram illustrating another example of the display screen of the protocol evaluation support apparatus according to Embodiment 1;

FIG. 12 is a diagram illustrating another example of the display screen of the protocol evaluation support apparatus according to Embodiment 1;

FIG. 13 is a diagram illustrating another example of the display screen of the protocol evaluation support apparatus according to Embodiment 1;

FIG. 14 is a diagram illustrating another example of the protocol data according to Embodiment 1;

FIG. 15A is a diagram illustrating an example of a display screen of a protocol evaluation support apparatus according to Embodiment 2;

FIG. 15B is a diagram illustrating an example of the display screen of the protocol evaluation support apparatus according to Embodiment 2;

FIG. 15C is a diagram illustrating an example of the display screen of the protocol evaluation support apparatus according to Embodiment 2;

FIG. 16 is a diagram illustrating a protocol evaluation support method of Comparative Example 1;

FIG. 17 is a diagram illustrating the protocol evaluation support method of Comparative Example 1; and

FIG. 18 is a diagram illustrating a protocol evaluation support method of Comparative Example 2.

### DESCRIPTION OF EMBODIMENTS

Hereinafter, a protocol evaluation support apparatus and a protocol evaluation support method according to an embodiment will be described in detail with reference to the drawings. The present invention is not to be interpreted as being limited to the contents described in the following embodiments. A person skilled in the art can easily understand that a specific configuration of the invention can be changed within a range not deviating from the idea or spirit of the invention.

In the configuration described below, the same reference numerals are used for the same parts or parts having similar functions in different drawings, and redundant descriptions thereof may be omitted. When there are a plurality of elements having the same or similar functions, descriptions may be made by adding different subscripts to the same reference numerals. However, when there is no need to distinguish between the plurality of elements, descriptions may be made by omitting the subscripts.

In this specification or the like, representations such as “first”, “second”, and “third” are added to identify components, and do not necessarily limit the number, order, or contents thereof. Further, a number for identifying the component is used for each context, and a number used in one context does not necessarily indicate the same configuration in another context. Furthermore, this does not preclude a component identified by a certain number from serving as a function of a component identified by another number.

In order to facilitate understanding of the configuration of the embodiment, a position, size, shape, range, and the like of each configuration illustrated in the drawings or the like may not represent an actual position, size, shape, range, and the like. Therefore, the configuration of the embodiment is not necessarily limited to the position, size, shape, range, and the like disclosed in the drawings or the like.

One feature of the embodiments described in detail below is that the embodiments support an evaluation of a protocol in which an experimental procedure in materials research is concisely expressed as a directed graph, as described below. Specifically, an “S” symbol expressing that paths included in the experimental procedure are simultaneously (or all at once) merged or branched is used to create an “SMe” symbol expressing simultaneous merging and an “SRe” symbol expressing simultaneous branching based on this “S” symbol. Then, by performing a predetermined operation using the created symbol as a starting point and removing extra elements in the path after development, information regarding the number of times each element appears can be handled correctly, and based on this information, an evaluation value such as cost is assigned to each element to calculate an overall evaluation value of the protocol.

### Embodiment 1

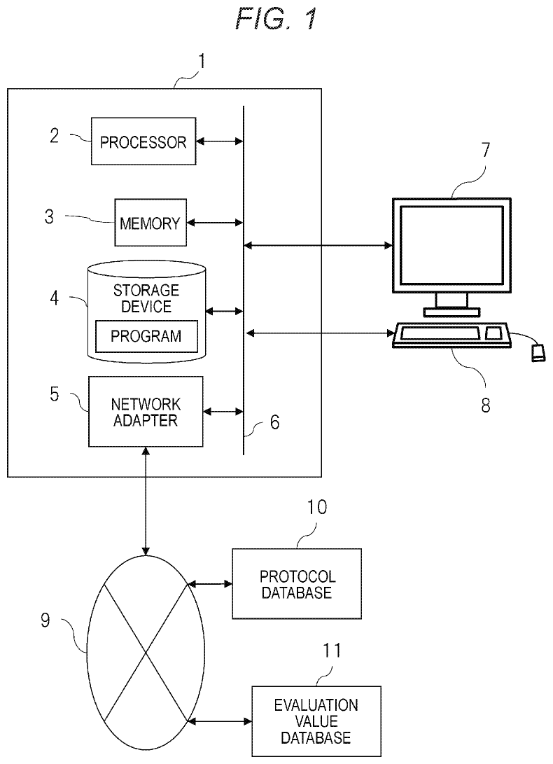

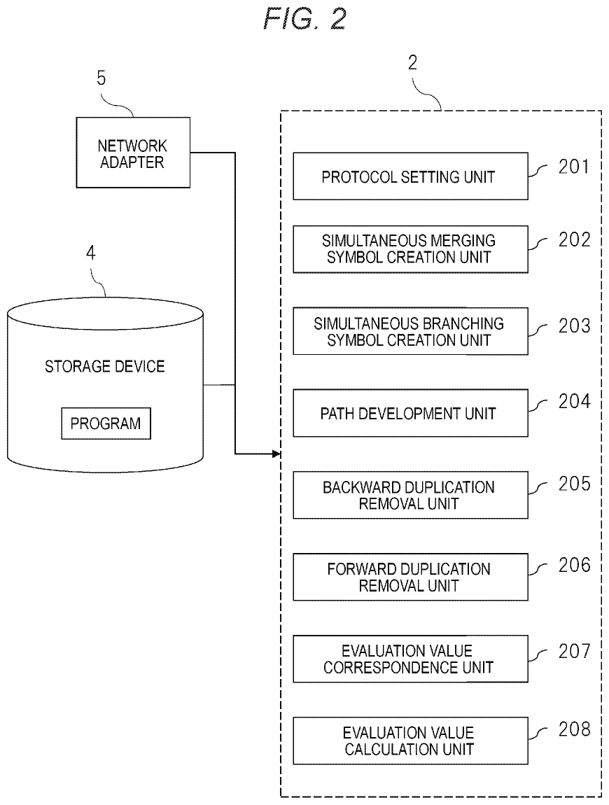

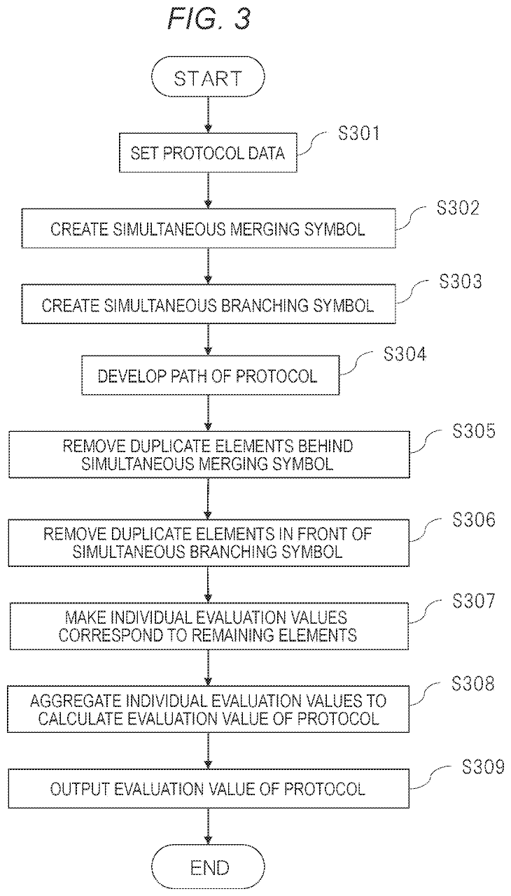

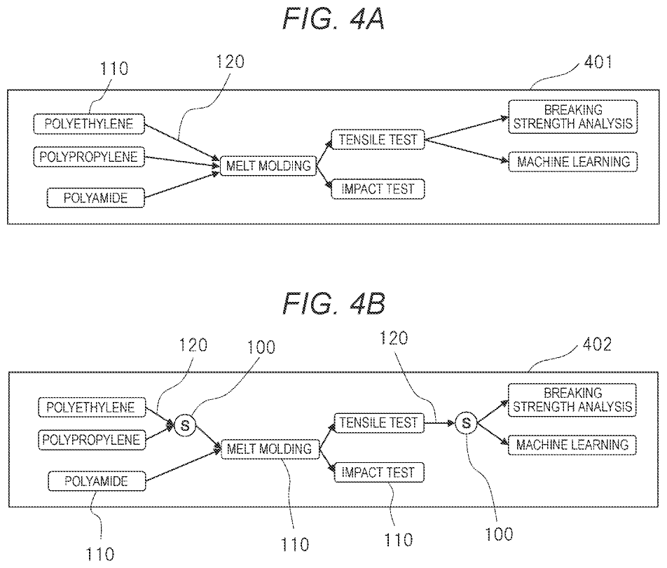

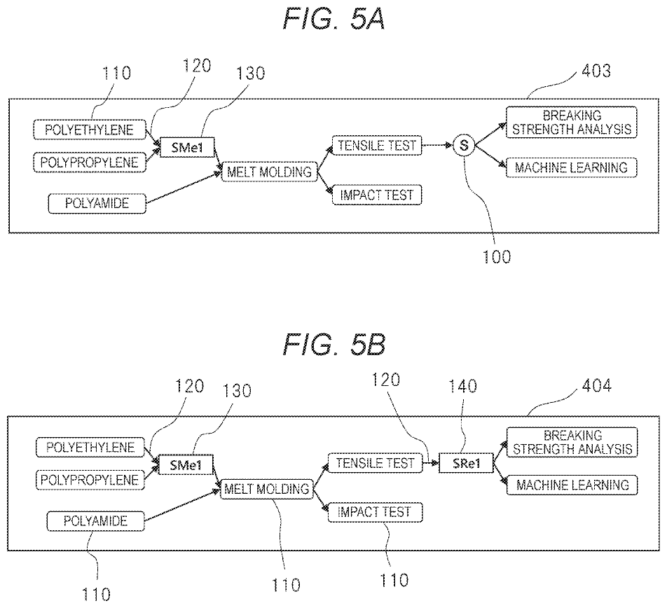

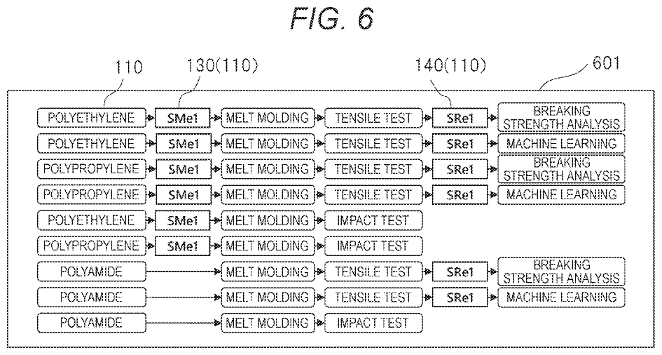

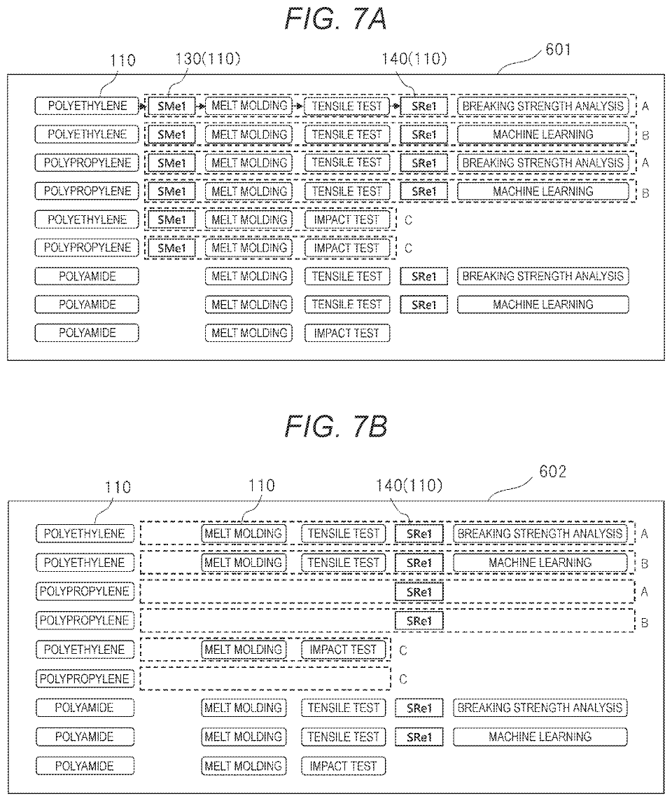

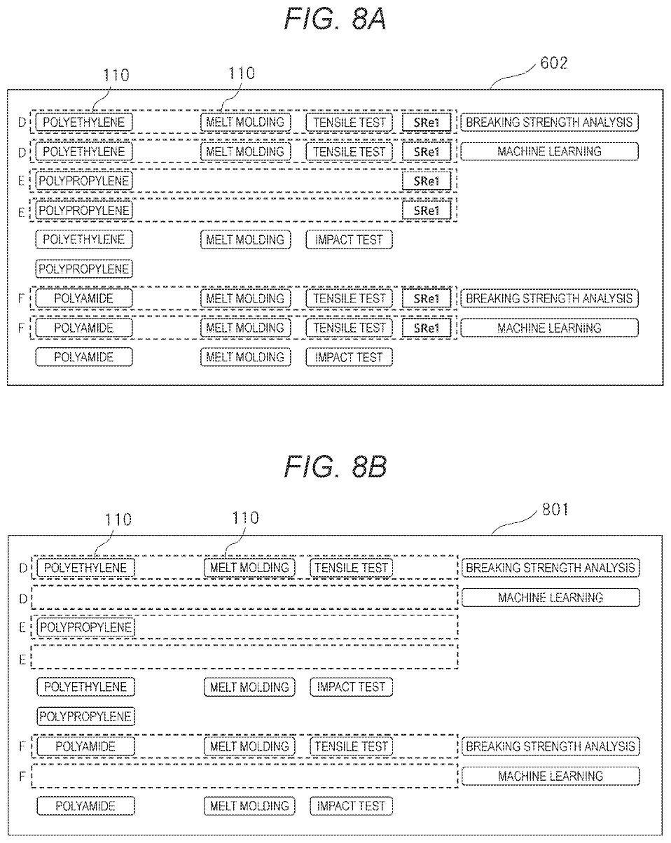

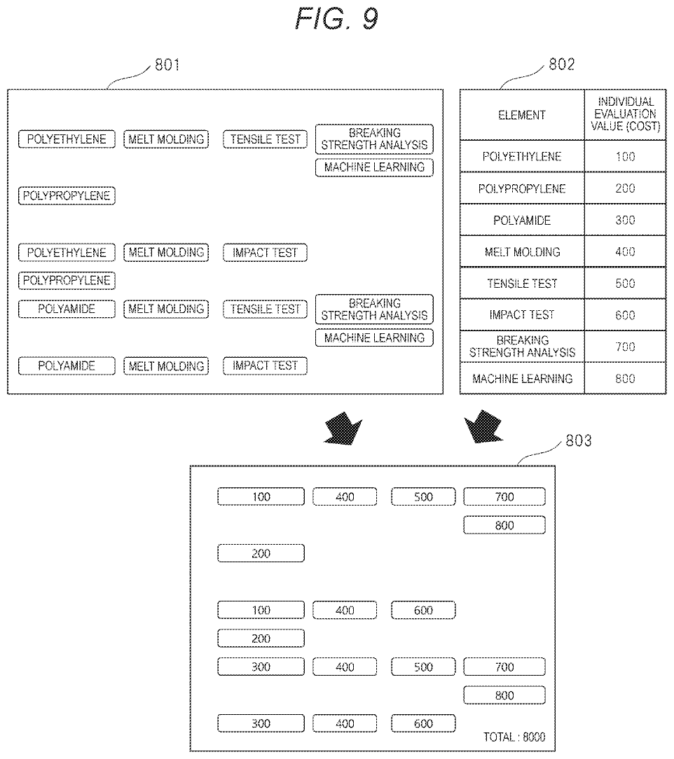

FIG. 1 is a diagram illustrating a hardware configuration of a protocol evaluation support apparatus according to Embodiment 1. FIG. 2 is a functional block diagram of the protocol evaluation support apparatus according to Embodiment 1. FIG. 3 is a diagram illustrating an example of a flow of a protocol evaluation support process according to Embodiment 1. FIGS. 4A and 4B are diagrams illustrating an example of protocol data according to Embodiment 1. FIGS. 5A and 5B are diagrams illustrating an example of creation processing according to Embodiment 1. FIG. 6 is a diagram illustrating an example of development processing according to Embodiment 1. FIGS. 7A and 7B, and FIGS. 8A and FIG. 8B are diagrams illustrating an example of removal processing according to Embodiment 1. FIG. 9 is a diagram illustrating an example of calculation processing according to Embodiment 1.

As illustrated in FIG. 1, a protocol evaluation support apparatus 1 includes a processor 2 as a processing device, a memory 3, a storage device 4, and a network adapter 5. The processor 2, the memory 3, the storage device 4, and the network adapter 5 are connected by a system bus 6 so as to be able to transmit and receive signals. Further, the protocol evaluation support apparatus 1 is connected to a protocol database 10 and an evaluation value database 11 via a network 9 so as to be able to transmit and receive signals, and is also connected to a display device 7 and an input device 8. Here, “being able to transmit and receive signals” indicates a state in which signals can be transmitted and received electrically or optically to each other or from one side to the other, regardless of whether the signals are transmitted and received in a wired manner or wirelessly.

The processor 2 is a device that controls an operation of each component or executes a program stored in the storage device 4. The memory 3 stores the program executed by the processor 2 and the interim progress of operation processing. The storage device 4 is a device that stores the program executed by the processor 2 and data necessary for executing the program, and specifically, includes a hard disk drive (HDD), a solid state drive (SSD), and the like. The network adapter 5 is for connecting the protocol evaluation support apparatus 1 to the network 9 such as a local area network (LAN), a telephone line, or the Internet. Various types of data handled by the processor 2 may be transmitted and received to and from the outside of the protocol evaluation support apparatus 1 via the network 9 such as a LAN.

The display device 7 is a device that displays a calculation result such as the overall evaluation value of the protocol by the protocol evaluation support apparatus 1, and specifically includes a liquid crystal display, a touch panel, or the like. The input device 8 is, for example, an operation device for an operator such as a user to perform an input operation on the protocol evaluation support apparatus 1, and specifically includes a keyboard, a mouse, a touch panel, or the like. Further, the input device 8 may include a pointing device such as a trackpad or a trackball.

The protocol database 10 is a database system that stores data of a protocol (hereinafter also referred to as protocol data) created in advance based on literature, past results, or the like. The protocol database 10 stores, for example, data of a plurality of types of protocols in which the process procedure (experimental procedure) in materials research is concisely expressed, in association with protocol IDs. The evaluation value database 11 is a database system that stores data of evaluation values (hereinafter referred to as evaluation value data) corresponding to a plurality of elements included in the protocol.

Here, an example of the experimental procedure in materials research is as follows. “Perform melt molding using both polyethylene and polypropylene, and polyamide alone, and conduct a tensile test and an impact test. The results (data) of the tensile test are used for breaking strength analysis and machine learning.”

Protocol data 401 expressing this experimental procedure is represented, for example, as a directed graph that can be concisely expressed, as illustrated in FIG. 4A. Further, for example, as illustrated in FIG. 4B, in the protocol represented as the directed graph in this way, an S symbol 100, which expresses that paths are simultaneously (also called all at once) merged or branched, is imparted at a predetermined timing. In this example, it is assumed that protocol data 402 in which the S symbol 100 is imparted in this way is stored in the protocol database 10.

A configuration of the storage unit that stores protocol data and evaluation value data is not particularly limited. The protocol data and the evaluation value data may be stored in the storage device 4 included in the protocol evaluation support apparatus 1, for example.

Next, with reference to FIG. 2, functional blocks of the protocol evaluation support apparatus 1 according to Embodiment 1 will be described. Respective functions illustrated in FIG. 2 may be implemented by dedicated hardware configured with an application specific integrated circuit (ASIC), a field-programmable gate array (FPGA), or the like, or may be implemented by software running on the processor 2. In the following, a case will be described in which the protocol evaluation support apparatus 1 is a computer, and the computer functions as each functional block by executing the program stored in the storage device 4.

The processor 2 of the protocol evaluation support apparatus 1 includes, as the functional blocks, a protocol setting unit 201, a simultaneous merging symbol creation unit 202, a simultaneous branching symbol creation unit 203, a path development unit 204, a backward duplication removal unit 205, a forward duplication removal unit 206, an evaluation value correspondence unit 207, an evaluation value calculation unit 208.

When the protocol evaluation support process is executed, the protocol setting unit 201 acquires predetermined protocol data from the protocol database 10 via the network adapter 5, for example, and executes setting processing for setting the protocol data as an evaluation target. As an example, the protocol setting unit 201 receives an input operation of the user input from the input device 8, acquires predetermined protocol data in accordance with an instruction of the user through the input operation (hereinafter referred to as an operation instruction), and sets the protocol data as the evaluation target. For example, the protocol data may be input by the user into the protocol evaluation support apparatus 1 as appropriate.

The simultaneous merging symbol creation unit 202 creates an “SMe symbol” expressing simultaneous merging based on the S symbol and contents of an arrow indicating a path in the protocol which is set as the evaluation target by the protocol setting unit 201. In other words, the simultaneous merging symbol creation unit 202 replaces a predetermined S symbol with the SMe symbol based on the S symbol and the contents of the arrow indicating the path in the protocol. To put it another way, the simultaneous merging symbol creation unit 202 assigns the SMe symbol as one of the elements to the predetermined S symbol based on the S symbol and the contents of the arrow indicating the path in the protocol.

For example, in the case of the protocol data 402 illustrated in FIG. 4B, for a portion where arrows 120 extending from a plurality of elements 110 are connected to the S symbol 100 and one arrow 120 extending from the S symbol 100 is connected to a next element 110, the S symbol 100 is replaced with the SMe symbol. That is, as illustrated in FIG. 5A, for the portion where the arrows 120 extending from the plurality of elements 110 are connected to the S symbol 100 and the one arrow 120 extending from the S symbol 100 is connected to the next element 110, the simultaneous merging symbol creation unit 202 creates protocol data 403 in which the S symbol 100 is replaced with SMe symbol 130.

The simultaneous branching symbol creation unit 203 creates an “SRe symbol” expressing simultaneous branching based on the S symbol and the contents of the arrow indicating the path in the protocol. In other words, the simultaneous branching symbol creation unit 203 replaces a predetermined S symbol with the SRe symbol based on the S symbol and the contents of the arrow indicating the path in the protocol. To put it another way, the simultaneous branching symbol creation unit 203 assigns the SRe symbol as one of the elements to the predetermined S symbol based on the S symbol and the contents of the arrow indicating the path in the protocol.

For example, in the case of the protocol data 403 illustrated in FIG. 5A, for a portion where an arrow 120 extending from one element 110 is connected to the S symbol 100 and a plurality of arrows 120 extending from the S symbol 100 are connected to a plurality of elements 110, the S symbol 100 is replaced with the SRe symbol. That is, as illustrated in FIG. 5B, for the portion where the arrow 120 extending from the one element 110 is connected to the S symbol 100 and the plurality of arrows 120 extending from the S symbol 100 are connected to the plurality of elements 110, the simultaneous branching symbol creation unit 203 creates protocol data 404 in which the S symbol 100 is replaced with the SRe symbol 140.

In this way, the simultaneous merging symbol creation unit 202 executes the creation processing for creating the SMe symbol (simultaneous merging symbol) that specifies simultaneous merging at a portion in the protocol where a plurality of elements simultaneously merge into one element. Further, the simultaneous branching symbol creation unit 203 executes the creation processing for creating the SRe symbol (simultaneous branching symbol) that specifies simultaneous branching at a portion in the protocol where one element branches simultaneously to a plurality of elements.

The path development unit 204 develops paths of the protocol based on the SMe symbol and SRe symbol in the protocol. In other words, the path development unit 204 develops a plurality of paths included in the process procedure expressed in the protocol into independent individual paths. In other words, the path development unit 204 executes development processing for developing the protocol after being subjected to the creation processing for each of the paths included in the process procedure.

The backward duplication removal unit 205 executes the removal processing for removing all of the elements that are duplicated in a process after the SMe symbol, that is, behind the SMe symbol for the protocol after being subjected to the development processing. In other words, the backward duplication removal unit 205 removes the elements that are duplicated in the process after the SMe symbol for the individual paths developed by the path development unit 204. Further, the forward duplication removal unit 206 executes the removal processing for removing all of the elements that are duplicated in a process before the SRe symbol, that is, in front of the SRe symbol, for the protocol after being subjected to the development processing. In other words, the forward duplication removal unit 206 removes the elements that are duplicated in the process before the SRe symbol for the developed individual paths. After the elements that are duplicated are removed by the backward duplication removal unit 205 and the forward duplication removal unit 206, the evaluation value correspondence unit 207 executes processing for making an evaluation value correspond to each of the elements remaining in the protocol as one piece of the calculation processing. Specifically, the evaluation value correspondence unit 207 acquires an individual evaluation value, which is an individual evaluation value of each of the elements remaining in the protocol after being subjected to the removal processing, from the evaluation value database 11, for example, and makes the individual evaluation value correspond to each of the elements.

The evaluation value calculation unit 208 calculates an evaluation value of the entire developed protocol (hereinafter referred to as an overall evaluation value) based on the individual evaluation values acquired from the evaluation value database 11. In other words, the evaluation value calculation unit 208 executes, as one piece of the calculation processing, processing for calculating the overall evaluation value, which is the evaluation value of the entire protocol, based on the individual evaluation values each of which is made to correspond to each of the elements by the evaluation value correspondence unit 207.

The overall evaluation value of the protocol calculated by the evaluation value calculation unit 208 in this way is then output to the user by the processor 2. In this example, an evaluation result including the overall evaluation value of the protocol is displayed on a screen of the display device 7. Although not illustrated, the processor 2 includes a display processing unit that executes display processing for displaying the evaluation result on the screen of the display device 7.

Next, with reference to FIG. 3, an example of a flow of protocol evaluation support process in the protocol evaluation support apparatus 1 will be described.

As illustrated in FIG. 3, when the protocol evaluation support process by the protocol evaluation support apparatus 1 is started, first, in step S301, the protocol setting unit 201 executes a setting step of setting a predetermined protocol as an evaluation target. That is, the protocol setting unit 201 executes the setting processing. As an example, the protocol setting unit 201 receives an input operation by the user, acquires predetermined protocol data stored in the protocol database 10 in accordance with the operation instruction, and sets the protocol as the evaluation target.

Next, in step S302, the simultaneous merging symbol creation unit 202 executes the creation processing. That is, a creation step of creating the SMe symbol at a merging portion in the protocol to which the S symbol is imparted is executed. When the protocol setting unit 201 acquires the protocol data 402 illustrated in FIG. 4B, the simultaneous merging symbol creation unit 202 detects a location where the plurality of arrows 120 enter the S symbol 100, and creates the protocol data 403 in which the S symbol 100 at the detected location is replaced with the SMe symbol 130 (see FIG. 5A).

Next, in step S303, the simultaneous branching symbol creation unit 203 executes the creation processing. That is, a creation step of creating the SRe symbol at a branching portion in the protocol to which the S symbol is imparted is executed. For example, when the protocol data 403 is created by the simultaneous merging symbol creation unit 202, the simultaneous branching symbol creation unit 203 detects a location where the plurality of arrows 120 come out from the S symbol 100, and creates the protocol data 404 in which the S symbol 100 at the detected location is replaced with the SRe symbol 140, as illustrated in FIG. 5B.

When a plurality of the SMe symbols 130 are created in the protocol, the SMe symbols 130 can be distinguished from each other by attaching individual numbers, and the like thereto. For example, the first SMe symbol is represented as “SMe1”, and the second SMe symbol is represented as “SMe2”. Similarly, when a plurality of the SRe symbols 140 are created in the protocol, the SRe symbols 140 can be distinguished from each other by attaching individual numbers, and the like thereto. For example, the first SRe symbol is represented as “SRe1”, and the second SRe symbol is represented as “SRe2”.

In step S304, the path development unit 204 executes the development processing. That is, a development step of developing the protocol after being subjected to the creation processing based on the SMe symbol (simultaneous merging symbol) and the SRe symbol (simultaneous branching symbol) is executed. As an example, the path development unit 204 develops the protocol for each of the plurality of paths included in the process procedure based on the protocol data 404 illustrated in FIG. 5B. In this case, all of the merging portions and the branching portions of the process procedure expressed in the protocol are handled as the meaning of “individual”, and the plurality of paths included in the process procedure are developed into individual paths (see FIG. 6).

Protocol data 601 of development result illustrated in FIG. 6 is a list of combinations of all of the paths that can be taken at the merging portion and the branching portion indicated in the protocol data 404. In other words, in this protocol data 601 of development result, the handling when a plurality of elements 110 are used simultaneously at one next element 110 or one element 110 is used simultaneously at a plurality of next elements 110 is not reflected. That is, the protocol after being subjected to the development processing includes a path in which extra elements 110 are combined. For example, when performing melt molding using polyethylene and polypropylene simultaneously, the number of times melt molding is performed is to be fewer than when performing melt molding using polyethylene and polypropylene individually.

Therefore, in step S305 and step S306, a removal step of removing, in the individual paths, all of the elements 110 that are duplicated in a process after the SMe symbol 130 and removing, in the individual paths, all of the elements 110 that are duplicated in a process before the SRe symbol 140, is executed. First, in step S305, the backward duplication removal unit 205 detects a path in which the elements 110 in the process after the SMe symbol (SMe1) 130 are the same, and executes removal processing for integrating the elements 110 that are duplicated and leaving only one element. After this removal processing, all of the SMe symbols (SMe1) are removed. However, in this processing, the SRe symbol (SRe1) is left as it is.

For example, as illustrated in FIG. 7A, in the protocol data 601, there are three sets of paths A, B, and C in which respective elements 110 behind the SMe symbol (SMe1) 130 are the same. In this case, the respective elements 110 behind the SMe symbol (SMe1) 130 are removed, leaving one path for each of the three sets of paths A, B, and C. That is, as illustrated in FIG. 7B, the backward duplication removal unit 205 creates protocol data 602 obtained by removing the respective elements 110 behind the SMe symbol (SMe1) 130, leaving one path for each of the three sets of paths A, B, and C. When there are the plurality of SMe symbols (SMe1, SMe2, and the like) 130 in the path, the removal processing described above is sequentially executed for each of the plurality of SMe symbols 130 with a different number.

Next, in step S306, the forward duplication removal unit 206 detects a path in which the elements 110 in the process before the SRe symbol (SRe1) 140 are the same, and executes the removal processing for integrating the elements 110 that are duplicated and leaving only one element. After this removal processing, all of the SRe symbols (SRe1) 140 are removed.

For example, as illustrated in FIG. 8A, in the protocol data 602, there are three sets of paths D, E, and F in which respective elements 110 in front of the SRe symbol (SRe1) 140 are the same. In this case, the respective elements 110 in front of the SRe symbol (SRe1) 140 are removed, leaving one path for each of the three sets of paths D, E, and F. That is, as illustrated in FIG. 8B, the forward duplication removal unit 206 creates protocol data 801 obtained by removing the respective elements in front of the SRe symbol (SRe1) 140, leaving one path for each of the three sets of paths D, E, and F. When there are the plurality of SRe symbols (SRe1, SRe2, and the like) 140 in the path, the removal processing described above is sequentially executed for each of the plurality of SRe symbols 140 with a different number. As a result, only the elements 110 actually required in the experimental procedure remain in the protocol data 801.

After the elements 110 that are duplicated are removed by the backward duplication removal unit 205 and the forward duplication removal unit 206 in this way, in step S307, a step of making an evaluation value correspond to each of the remaining elements 110 is executed as one of the calculation steps. That is, the evaluation value correspondence unit 207 executes processing for making the evaluation value correspond to each of the remaining elements 110. The evaluation value correspondence unit 207 acquires evaluation value data from the evaluation value database 11, for example, and makes each of individual evaluation values correspond to each of the remaining elements 110. For example, as illustrated in FIG. 9, the evaluation value correspondence unit 207 creates data 803 in which the evaluation value is made to correspond to each of the elements 110, based on the protocol data 801 and evaluation value data 802 indicating the correspondence relation between each element and the individual evaluation value.

The evaluation value data can also be appropriately input by the user, for example, by operating the input device 8. That is, the evaluation value correspondence unit 207 can also receive an input operation of the individual evaluation value by the user and make the received individual evaluation value correspond to each of the elements remaining after the removal processing. Further, the evaluation value data acquired from the evaluation value database 11 by the evaluation value correspondence unit 207 may be allowed to be modified by the user as necessary. The items of the evaluation value can be freely set. For example, when the protocol is the experimental procedure in materials research, the items of the evaluation value include, in addition to cost, for example, work man-hours, required time, and the like.

Next, in step S308, the calculation processing for calculating the overall evaluation value of the protocol is executed based on the individual evaluation values each of which is made to correspond to each element. That is, the evaluation value calculation unit 208 aggregates the evaluation values each of which is made to correspond to each element 110 by the evaluation value correspondence unit 207, and calculates the overall evaluation value that is an evaluation value of the entire protocol. In the example illustrated in FIG. 9, the value “Total: 8000” included in the data 803 is the overall evaluation value of the protocol, and is the calculation result by the evaluation value calculation unit 208.

After that, in step 309, the display processing for displaying, for example, the overall evaluation value of the protocol calculated by the evaluation value calculation unit 208, as the calculation result of the evaluation value, on the screen of the display device 7, is executed. That is, in step S309, the calculation result including the overall evaluation value of the protocol is output to the user.

In the protocol evaluation support process described above, the order of steps S302 and S303 can be interchanged. Even when the order of steps S302 and S303 are interchanged, the evaluation value of the protocol will not be affected. Similarly, the order of steps S305 and S306 can be interchanged, and even when the order of steps S305 and S306 are interchanged, the evaluation value of the protocol will not be affected.

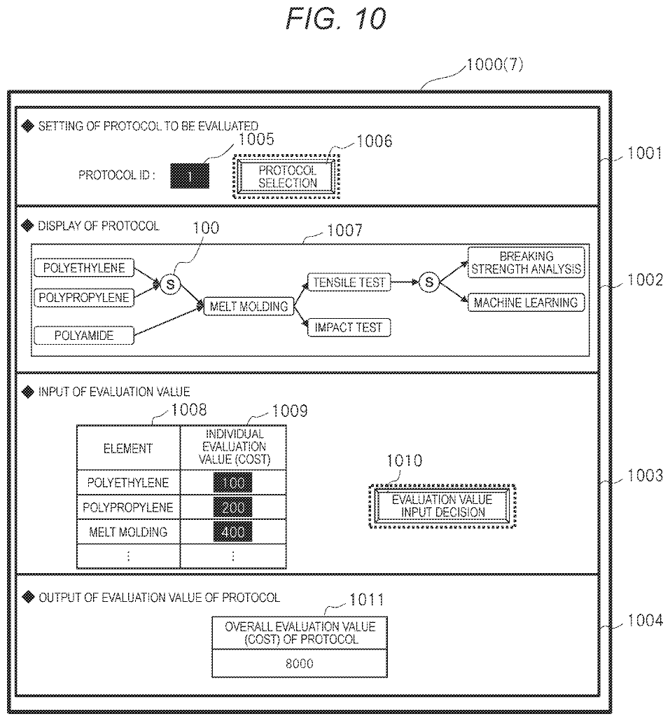

FIG. 10 is a diagram illustrating an example of a display screen of the protocol evaluation support apparatus. As illustrated in FIG. 10, when executing the protocol evaluation support process, an input/output screen 1000 including, for example, components configuring a graphical user interface (GUI) is displayed on the display device 7. As an example, the input/output screen 1000 is configured with a first display section 1001, a second display section 1002, a third display section 1003, and a fourth display section 1004.

On the first display section 1001, GUI components for setting the protocol that is an evaluation target are displayed. For example, on the first display section 1001, an ID input field 1005 for the user to input a protocol ID, and a protocol selection button 1006 for deciding the protocol ID are displayed. On the second display section 1002, a protocol 1007 that is set as the evaluation target is displayed. As an example, on the second display section 1002, the protocol before the creation processing described above is executed is displayed.

On the third display section 1003, GUI components and the like for making each of the individual evaluation values correspond to each element 110 remaining in the protocol after being subjected to the removal processing described above are displayed. For example, on the third display section 1003, a list 1008 of the elements 110 remaining after the removal processing is displayed, and an evaluation value input field 1009 for inputting the individual evaluation value corresponding to each element 110 and an evaluation value input decision button 1010 for deciding the input individual evaluation value are also displayed. On the fourth display section 1004, an overall evaluation value 1011 of the protocol, which is the calculation result of the evaluation value, is displayed.

The user inputs a predetermined protocol ID into the ID input field 1005 and clicks the protocol selection button 1006 in the first display section 1001. With this, predetermined protocol data is read from the protocol database 10, and the protocol 1007 corresponding to the input ID is displayed on the second display section 1002. In the example illustrated in FIG. 10, “1” is input as the protocol ID into the ID input field 1005 of the first display section 1001, and the protocol 1007 corresponding to ID: 1 is displayed on the second display section 1002.

In this case, the protocol evaluation support process described above is executed, and the list 1008 of the remaining elements 110 is displayed on the third display section 1003. Further, the individual evaluation value corresponding to each element 110 is automatically input into and displayed on the evaluation value input field 1009 based on the evaluation value data read from the evaluation value database 11. The user rewrites the individual evaluation value input into the evaluation value input field 1009 as necessary, and then clicks the evaluation value input decision button 1010. With this, the individual evaluation value corresponding to each element 110 is decided, and the overall evaluation value 1011 of the protocol is displayed on the fourth display section 1004.

In the example illustrated in FIG. 10, on the third display section 1003, values of “100”, “200”, and “400” are displayed as individual evaluation values (costs) corresponding to the elements of “polyethylene”, “polypropylene”, and “melt molding”, respectively. On the fourth display section 1004, a value of “8000”, which is the total of the individual evaluation values, is displayed as the overall evaluation value 1011 of the protocol.

In this way, in the protocol evaluation support apparatus 1 according to the present embodiment, the calculation result for the evaluation value of the protocol can be obtained relatively easily. Therefore, the work of the user when setting the process procedure is saved. Since the protocol including a plurality of work processes is stored in the form of a concise directed graph that does not include extra duplicate elements, a capacity of the database or the storage device can be efficiently used. Furthermore, the time required for the user to check the protocol and grasp the contents thereof can be reduced.

In the present embodiment, the individual evaluation value is automatically input into the third display section 1003 of the input/output screen 1000 and the user can rewrite this individual evaluation value, but the individual evaluation value may not be automatically input and may be input by the user via the input device 8, for example. For example, the evaluation value correspondence unit 207 may receive an input operation of the individual evaluation value by the user, and may make the received individual evaluation value correspond to each of the elements remaining after the removal processing.

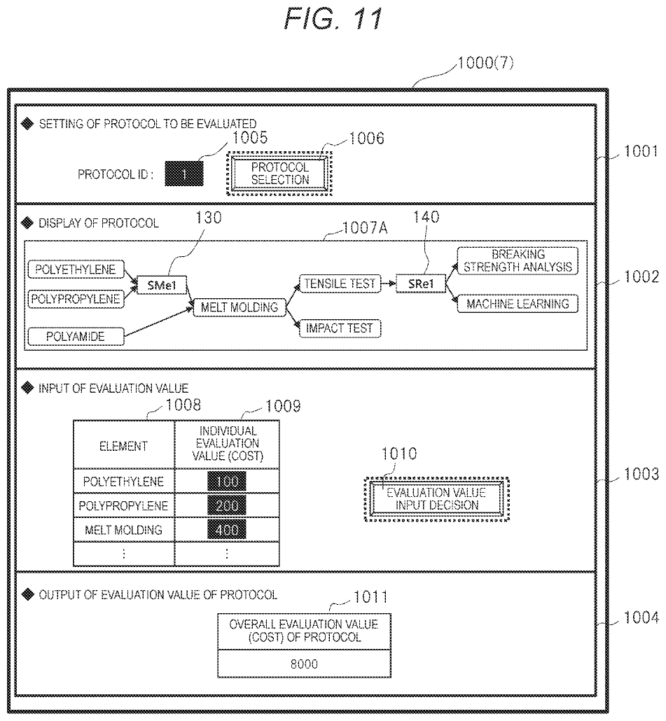

In the present embodiment, as an example of the input/output screen 1000 displayed on the display device 7, a case where the protocol 1007 before the creation processing is executed is displayed on the second display section 1002 is described, but the protocol 1007 displayed on the second display section 1002 is not limited thereto. For example, as illustrated in FIG. 11, on the second display section 1002, a protocol 1007A after the creation processing is executed may be displayed. That is, the protocol 1007A in which the S symbol 100 is replaced with the SMe symbol 130 or the SRe symbol 140 may be displayed on the second display section 1002.

Further, in the present embodiment, as an example of the input/output screen 1000 displayed on the display device 7, a case where only one protocol is displayed is described, but a plurality of protocols may be displayed on the input/output screen 1000 of the display device 7. Furthermore, as the input/output screen 1000 displayed on the display device 7, a case where one individual evaluation value and an overall evaluation value, which are costs, are displayed is described, but a plurality of types of individual evaluation values and overall evaluation values may be displayed.

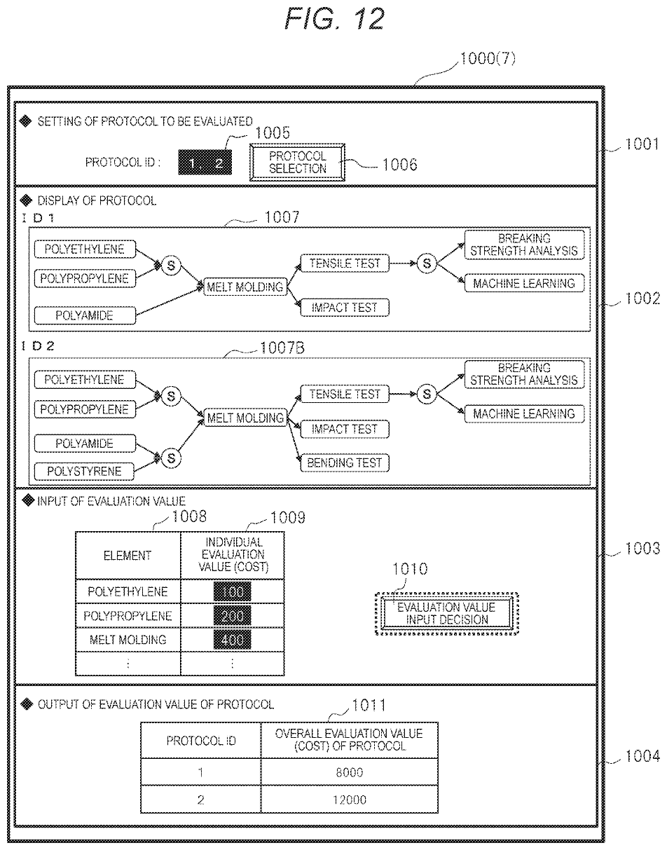

For example, in the example illustrated in FIG. 12, two protocol IDs “1” and “2” are input into the ID input field 1005 of the first display section 1001, and two protocols 1007 and 1007B respectively corresponding to IDs: 1 and 2 are displayed on the second display section 1002. On the fourth display section 1004, two values of “8000” and “12000” respectively corresponding to the two protocol IDs are displayed as the overall evaluation values 1011 of the protocol.

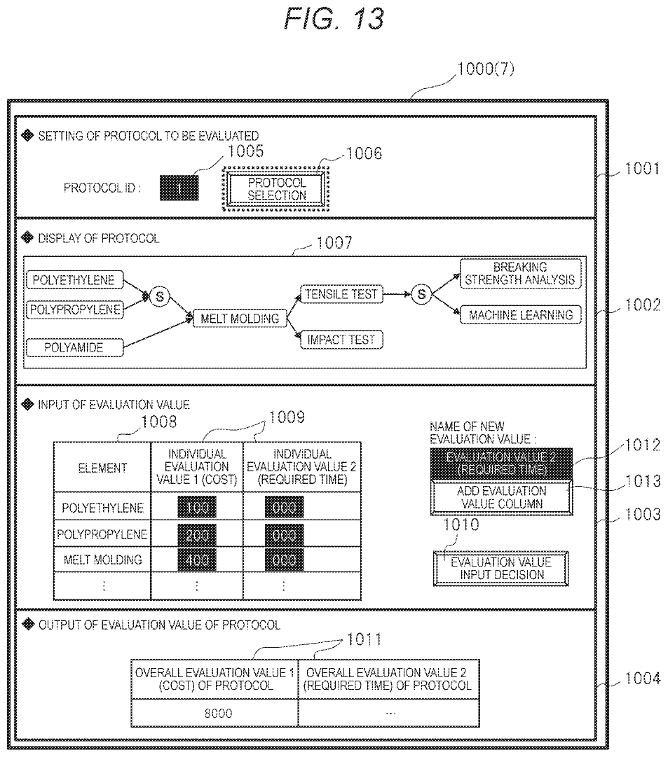

Further, in the example illustrated in FIG. 13, an item input field 1012 for inputting the item of individual evaluation value and an “add evaluation value column” button 1013, which is a button to decide the addition of a column of the individual evaluation value, are set in the third display section 1003. When the user inputs, for example, “required time”, as an item name of the individual evaluation value into the item input field 1012 and clicks the button 1013, a field for the individual evaluation value corresponding to each element is additionally set. With this, in the third display section 1003, as the evaluation value input field 1009, in addition to “cost”, which is individual evaluation value 1, the item of “required time”, which is individual evaluation value 2, is additionally set, and it becomes possible to input the required time (individual evaluation value 2) corresponding to each element. In the fourth display section 1004, as the overall evaluation value 1011 of the protocol, in addition to overall evaluation value 1 which is the cost, a field for overall evaluation value 2 which is the required time is additionally set.

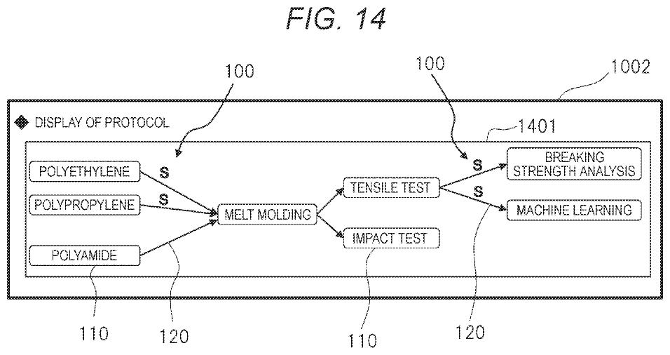

Further, in the embodiment described above, the S symbol 100, which means “simultaneous”, is imparted to portions in the protocol where simultaneous merging and simultaneous branching occur. That is, when performing the protocol evaluation support process, the S symbol 100 is displayed on the second display section 1002 configuring the input/output screen 1000 of the display device 7 as one of the elements 110 connected by the arrow 120. However, a display format of the S symbol 100, which means “simultaneous”, is not limited thereto. For example, as illustrated in FIG. 14, in a protocol 1401 displayed on the second display section 1002, the meaning of “simultaneous” may be assigned to the arrows 120 of the portions where simultaneous merging and simultaneous branching occur and the S symbol 100 may be displayed adjacent to the arrow 120.

In this case, it becomes unnecessary to handle the S symbol 100 as one of the elements 110. That is, the number of elements included in the protocol can be reduced. Therefore, it is possible to express the contents of the process procedure including the plurality of paths concisely as the protocol which is the directed graph. As an example, in the protocol 1401 illustrated in FIG. 14, the S symbol 100 is written above the arrow 120, but by making the color and shape of the arrow 120 different from the other arrows 120, the arrow 120 itself may also serve as the S symbol 100.

### Embodiment 2

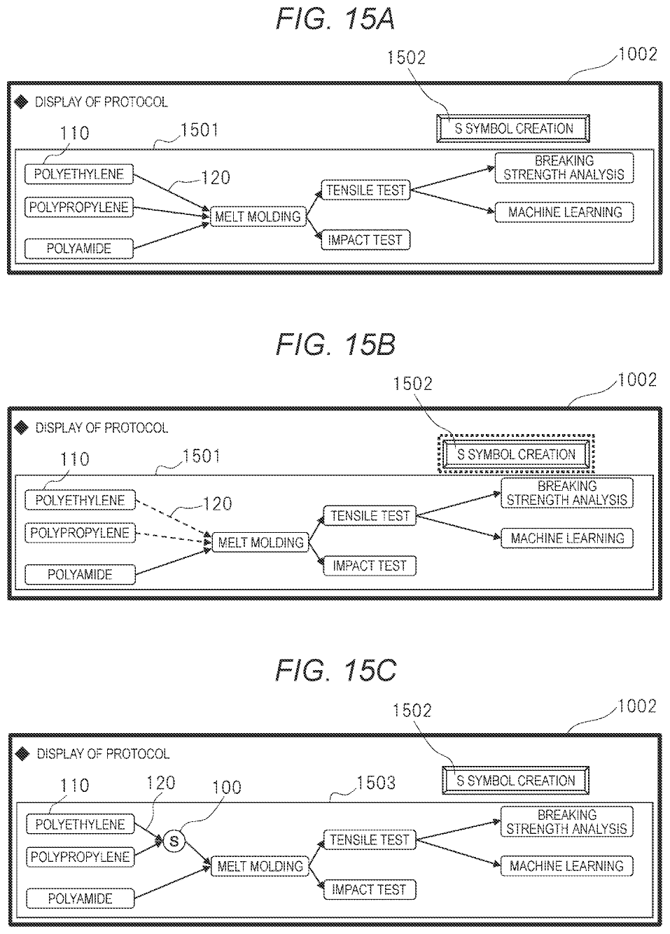

FIGS. 15A, 15B, and 15C are diagrams illustrating an example of a display screen of a protocol evaluation support apparatus according to Embodiment 2. In FIGS. 15A, 15B, and 15C, only the second display section 1002 that configures the input/output screen 1000 displayed on the display device 7 is illustrated. The first display section 1001, the third display section 1003, and the fourth display section 1004 that configure the input/output screen 1000 according to Embodiment 2 are the same as those in Embodiment 1, and thus illustration thereof is omitted.

In Embodiment 1, a case where the protocol data in which the S symbol 100 is imparted is stored in the protocol database 10 is described. That is, in Embodiment 1, an example in which the protocol setting unit 201 reads the protocol data in which the S symbol 100 is imparted from the protocol database 10 or the like is described.

In contrast, in Embodiment 2, an example in which protocol data in which the S symbol 100 is not imparted is stored in the protocol database 10 is described. That is, in Embodiment 2, the protocol setting unit 201 reads the protocol data in which the S symbol is not imparted from the protocol database 10, and then imparts the S symbol 100 to the read protocol in accordance with the operation instruction of the user. For example, before the creation processing described above, the protocol setting unit 201 included in the processor 2 receives an input operation of the S symbol 100 by the user, and executes impartment processing for imparting the S symbol 100 to a predetermined position in the protocol which is set as an evaluation target.

Therefore, in Embodiment 2, when a predetermined protocol is acquired and set as the evaluation target by the protocol setting unit 201, a protocol 1501 in which the S symbol 100 is not imparted is displayed on the second display section 1002, as illustrated in FIG. 15A. Then, for example, the protocol setting unit 201 receives the input operation by the user, and adds the S symbol 100 as appropriate to a predetermined position in the protocol 1501 represented by a directed graph, as illustrated in FIGS. 15B and 15C. On the second display section 1002, an S symbol creation button 1502 for the user to instruct to add the S symbol 100 to the protocol 1501 is displayed.

For example, when additionally creating the S symbol 100 at a portion in the protocol 1501 where simultaneous merging occurs, first, as illustrated in FIG. 15B, a plurality of arrows 120 of the portion where simultaneous merging occurs are selected in the protocol 1501 displayed on the second display section 1002. In this example, two arrows 120 are selected, and the two selected arrows 120 are indicated by dotted lines in FIG. 15B.

With the plurality of arrows 120 selected in this way, the user clicks the S symbol creation button 1502. With this, as illustrated in FIG. 15C, a protocol 1503 in which the S symbol 100 is imparted to the portion corresponding to the two selected arrows 120 is created and displayed on the second display section 1002. After that, as in Embodiment 1, removal processing and calculation processing are executed as appropriate.

Also in such a protocol evaluation support apparatus 1 according to Embodiment 2, as in Embodiment 1, the calculation result for the evaluation value of the protocol can be obtained relatively easily. Therefore, the work of the user when setting a work process is saved. Further, the contents of the process procedure including a plurality of paths are concisely expressed as the protocol, which is the directed graph. Therefore, a capacity of the database or the storage device can be efficiently used. Furthermore, the time required for the user to check the protocol and grasp the contents thereof can be reduced.

In Embodiment 2, the user is allowed to add the S symbol 100 to the protocol 1501, but the user may also be allowed to add or delete the element 110 or the arrow 120 along with the S symbol 100.

### Comparative Example 1

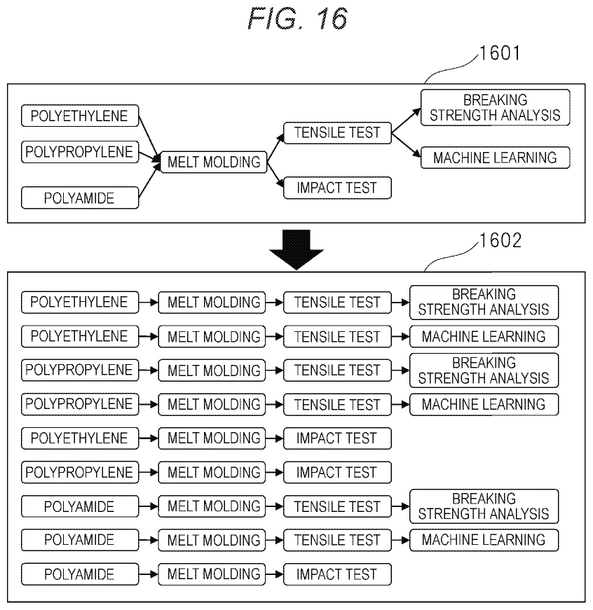

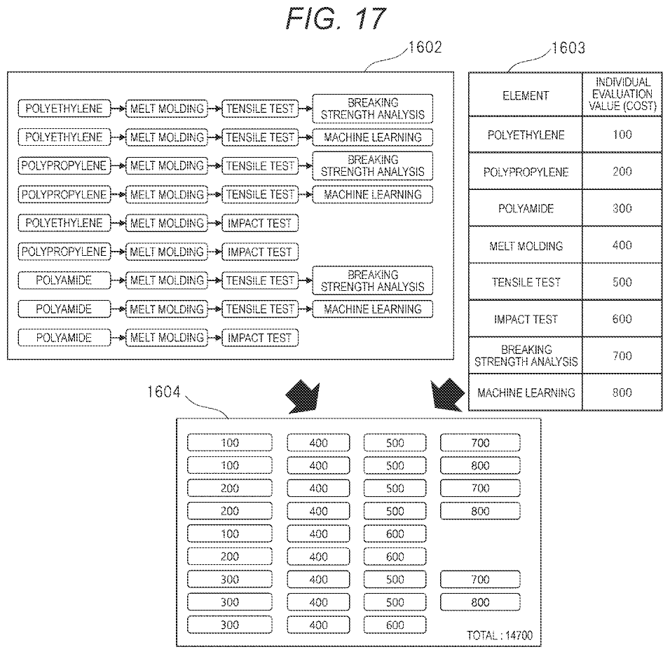

FIGS. 16 and 17 are diagrams illustrating a protocol evaluation support method according to Comparative Example 1.

As illustrated in FIG. 16, the protocol evaluation support method according to Comparative Example 1 is different from the protocol evaluation support method according to Embodiment 1 in that both “merging” and “branching” of each path are handled as the meaning of “individual” when developing the paths included in the protocol using a protocol 1601 in which a work procedure is expressed as a directed graph without using an SMe symbol and an SRe symbol. A work process expressed as the protocol has the following contents as in Embodiment 1.

The work process: “Perform melt molding using both polyethylene and polypropylene, and polyamide alone, and conduct a tensile test and an impact test. The results (data) of the tensile test are used for breaking strength analysis and machine learning.”

In the protocol 1601 in which the work procedure is expressed as the directed graph without using the SMe symbol and the SRe symbol, it is not possible to express the contents such as performing melt molding using polyethylene and polypropylene simultaneously, or contents such as using data obtained from the tensile test simultaneously (using the same data) for breaking strength analysis and machine learning.

In Comparative Example 1, as illustrated in FIG. 16, data 1602, which is the result of developing the paths of the work process, is obtained based on the protocol 1601, but it is not possible to specify which elements are extra elements in the data 1602.

Therefore, as illustrated in FIG. 17, even when data 1604 including an overall evaluation value of the protocol is created based on the data 1602, which is the development result, and evaluation value data 1603 indicating the correspondence relation between each element and the individual evaluation value, an appropriate overall evaluation value cannot be obtained. The appropriate value of the overall evaluation value of the protocol described above is “8000” as illustrated in Embodiment 1. However, in Comparative Example 1, the overall evaluation value is “14700” because extra elements are included. As such, the protocol evaluation support method according to Comparative Example 1 is difficult to use for protocol evaluation support because the overall evaluation value of the protocol is calculated excessively.

### Comparative Example 2

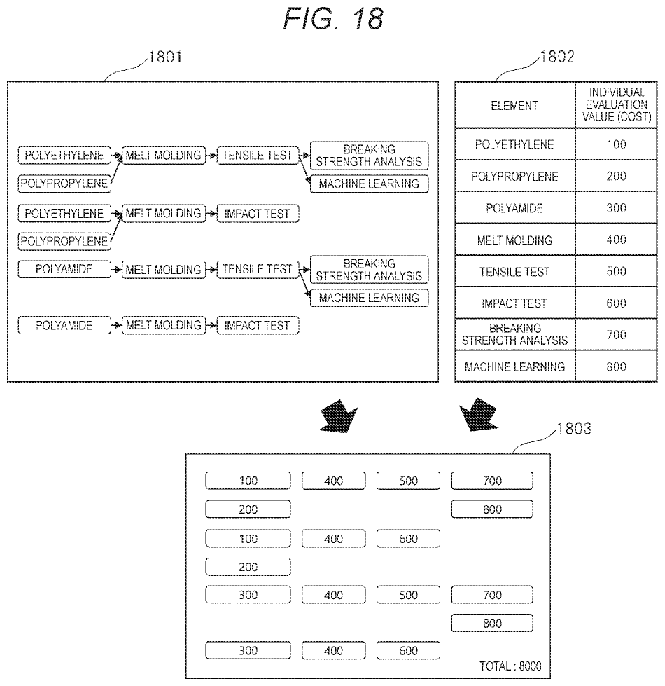

FIG. 18 is a diagram illustrating a protocol evaluation support method according to Comparative Example 2.

As illustrated in FIG. 18, the protocol evaluation support method according to Comparative Example 2 is different from the protocol evaluation support method according to Embodiment 1 in that a protocol 1801 in which a work procedure is expressed as a directed graph is created using both “merging” and “branching” in a work process as the meaning of “individual” and without using an SMe symbol and an SRe symbol, and an overall evaluation value of the protocol is calculated from the protocol 1801. The work process expressed as the protocol has the following contents as in Embodiment 1.

The work process: “Perform melt molding using both polyethylene and polypropylene, and polyamide alone and conduct a tensile test and an impact test. The results (data) of the tensile test are used for breaking strength analysis and machine learning.”

In the protocol 1801 illustrated in FIG. 18, the work process is expressed as the directed graph, but “merging” and “branching” in the protocol are all have the meaning of “individual”. Therefore, when creating the protocol, it is necessary to express all of the paths included in the protocol individually.

In the protocol evaluation support method according to Comparative Example 2, unlike the case of Comparative Example 1, when data 1803 including the overall evaluation value of the protocol is created based on the protocol 1801 illustrated in FIG. 18 and evaluation value data 1802 indicating the correspondence relation between each element and the individual evaluation value, it may be possible to obtain an appropriate value as the overall evaluation value of the protocol.

However, in the protocol evaluation support method according to Comparative Example 2, it is not always possible to obtain an appropriate value as the overall evaluation value of the protocol. Further, the protocol evaluation support method according to Comparative Example 2 is inefficient because a redundant expression method is to be adopted. In other words, the same element appears many times in one protocol. For this reason, the protocol evaluation support method according to Comparative Example 2 requires an excessive data storage capacity, makes it difficult for the user to grasp the content when checking, and increases the amount of time required for checking, which makes it difficult to use the protocol evaluation support method according to Comparative Example 2 for protocol evaluation support.

What is claimed is:

1. A protocol evaluation support apparatus that supports an evaluation of a protocol in which a process procedure including a plurality of paths that connect a plurality of elements is expressed, the protocol evaluation support apparatus comprising:
a processing device configured to execute
creation processing for creating a simultaneous merging symbol that specifies simultaneous merging at a portion in the protocol where a plurality of the elements simultaneously merge into one element, and creating a simultaneous branching symbol that specifies simultaneous branching at a portion in the protocol where one element simultaneously branches to a plurality of the elements,
development processing for developing the protocol after being subjected to the creation processing for each of the paths included in the process procedure,
removal processing for removing all of the elements that are duplicated in a process after the simultaneous merging symbol and removing all of the elements that are duplicated in a process before the simultaneous branching symbol for the protocol after being subjected to the development processing, and
calculation processing for making each of individual evaluation values correspond to each of the remaining elements and calculating an overall evaluation value of the protocol based on the individual evaluation values made to correspond to the remaining elements for the protocol after being subjected to the removal processing.

2. The protocol evaluation support apparatus according to claim 1, wherein
as the creation processing, the processing device creates the simultaneous merging symbol at a portion in the protocol at which a plurality of the elements are connected to one element and to which a simultaneous symbol is imparted, and creates the simultaneous branching symbol at a portion in the protocol at which one element is connected to a plurality of the elements and to which the simultaneous symbol is imparted.

3. The protocol evaluation support apparatus according to claim 2, wherein
before the creation processing, the processing device receives an input operation of the simultaneous symbol by an operator, and executes impartment processing for imparting the simultaneous symbol to a predetermined position in the protocol which is set as an evaluation target.

4. The protocol evaluation support apparatus according to claim 1, wherein
the protocol is stored in a storage unit in association with a protocol ID, and
before the creation processing, the processing device receives an input operation of the protocol ID by an operator to read the protocol corresponding to the protocol ID from the storage unit, and executes setting processing for setting the read protocol as an evaluation target.

5. The protocol evaluation support apparatus according to claim 1, wherein
when executing the calculation processing, the processing device receives an input operation of the individual evaluation values by an operator, and makes the received individual evaluation values correspond to the elements remaining after the removal processing, respectively.

6. The protocol evaluation support apparatus according to claim 1, wherein
the processing device executes display processing for displaying the overall evaluation value of the protocol calculated by the calculation processing on a screen of a display device.

7. The protocol evaluation support apparatus according to claim 6, wherein
as the display processing, the processing device further displays the protocol before being subjected to the creation processing on the screen of the display device.

8. The protocol evaluation support apparatus according to claim 6, wherein
as the display processing, the processing device further displays the protocol after being subjected to the creation processing on the screen of the display device.

9. The protocol evaluation support apparatus according to claim 6, wherein
as the display processing, the processing device further displays the elements remaining in the protocol after being subjected to the development processing and the individual evaluation values respectively corresponding to the elements on the screen of the display device.

10. The protocol evaluation support apparatus according to claim 1, wherein
the individual evaluation values and the overall evaluation value include a value for evaluating cost.

11. The protocol evaluation support apparatus according to claim 1, wherein
the process procedure is an experimental procedure in materials research.

12. A protocol evaluation support method that supports an evaluation of a protocol in which a process procedure including a plurality of paths that connect a plurality of elements is expressed, the protocol evaluation support method comprising:
as steps executed by a computer,
a creation step of creating a simultaneous merging symbol that specifies simultaneous merging at a portion in the protocol where a plurality of the elements simultaneously merge into one element, and creating a simultaneous branching symbol that specifies simultaneous branching at a portion in the protocol where one element simultaneously branches to a plurality of the elements;
a development step of developing the protocol for each of the paths included in the process procedure;
a removal step of removing all of the elements that are duplicated in a process after the simultaneous merging symbol and removing all of the elements that are duplicated in a process before the simultaneous branching symbol for the protocol developed in the development step; and
a calculation step of making each of individual evaluation values correspond to each of the elements remaining after the removal step, and calculating an overall evaluation value of the protocol based on the individual evaluation values made to correspond to the remaining elements.
